(19) United States
(12) Patent Application Publication
(10) Pub. No.: US 2005/0241200 A1
(43) Pub. Date: Nov. 3, 2005

(54) System and method for making labels with electronic components

(76) Inventor: You-Chung Hsu, San Marino, CA (US)

Correspondence Address: SHELDON & MAK, INC, 225 SOUTH LAKE AVENUE, 9TH FLOOR, PASADENA, CA, 91101, US

(21) Appl. No.: 10/835,846

(22) Filed: Apr. 29, 2004

(51) Int. Cl. G09F 3/10

(52) U.S. Cl. 40/638

(57) ABSTRACT

A method of making a label, the method having the steps of providing a first label; providing an identification strip; mounting the identification strip to the first label; providing a second label; and coupling the second label to the first label without using an adhesive.

### BACKGROUND

The present invention relates to labels incorporating electronic components and a method of making labels incorporating electronic components.

Devices for preventing theft of articles from a store are known. For example, it is known to use a pair of metallic strips attached to an article to prevent theft of the article. In such anti-theft systems, a magnetic field is established at an exit of a store. When the metallic strips enter the magnetic field, the magnetic field is disturbed and the presence of the article is thereby detected. An alarm may then be sounded to prevent theft from taking place.

Other systems are also known, including radio frequency systems. Radio frequency systems use a radio frequency detection and emission device attached to an article. A first radio frequency is emitted to the frequency detection and emission device. In response, the frequency detection and emission device emits a second radio frequency which is detected by a detector. In addition to preventing theft, radio frequency devices are being attached to garments and other products as identification strips to help track inventory.

Prior attempts to incorporate anti-theft and other radio frequency devices into labels have shortcomings. There is a need for a system and method for incorporating anti-theft strips and radio frequency devices into labels that solves the shortcomings of the prior art.

### SUMMARY

Accordingly, the present invention, according to an embodiment, is directed to a method of making a label having the steps of providing a first label and providing an identification strip. The identification strip is mounted to the first label. A second label is provided. The second label is coupled to the first label without using an adhesive.

Optionally, the method comprises coating a portion of the identification strip with an adhesive before mounting the identification strip to the first label. Optionally, the identification strip comprises an adhesive and a backing layer covering the adhesive and the method further comprises removing the backing layer from the identification strip to expose the adhesive before mounting the identification strip to the first label. Optionally, the second label is coupled to the first label using an ultrasonic sealing device.

The present invention is also directed to a system for making a label. According to an embodiment, the system has a first label dispenser dispensing a first label, an identification strip dispenser, dispensing identification strips, and an assembly unit for mounting the identification strips onto the first label. The system also has a second label dispenser dispensing a second label and a sealer for sealing the first label to the second label without using an adhesive.

Optionally, the identification strips comprise a removable backing, and the system further comprises an identification strip backing takeup roll. Optionally, the system also has a finish label takeup roll.

The present invention is also directed to a label having: a first label; an identification strip mounted on the first label; and a second label sealed to the first label without an adhesive.

### BRIEF DESCRIPTION OF THE DRAWINGS

A better understanding of the present invention will be had with reference to the accompanying drawings in which:

FIG. 1 is a side perspective view of a system for producing labels according to an embodiment of the present invention;

FIG. 2 is an enlarged side perspective view of the ultrasonic cutting device shown in FIG. 1; and

FIG. 3 is a side cross sectional view of a label having an identification strip according to an embodiment of the present invention; and

FIG. 4 is a flowchart showing the steps of a method for producing labels according to an embodiment of the present invention.

### DETAILED DESCRIPTION

The present invention is directed to a system and method for producing labels having an identification strip embedded therein. As used herein, “identification strip” refers to magnetic, radio frequency, and other types of anti-theft and identification systems utilizing a component placed on a strip suitable for embedding in a clothing label. An example of an identification strip usable with the present invention is disclosed, for example, in U.S. Pat. No. 5,006,856, the contents of which are hereby incorporated herein by reference.

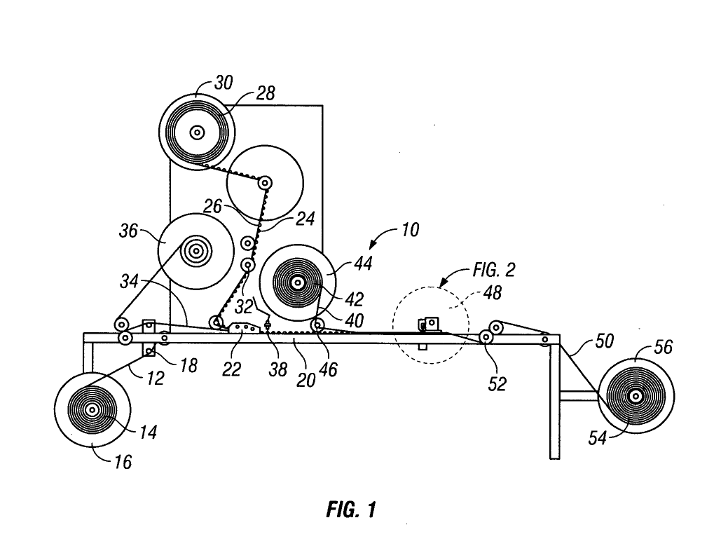

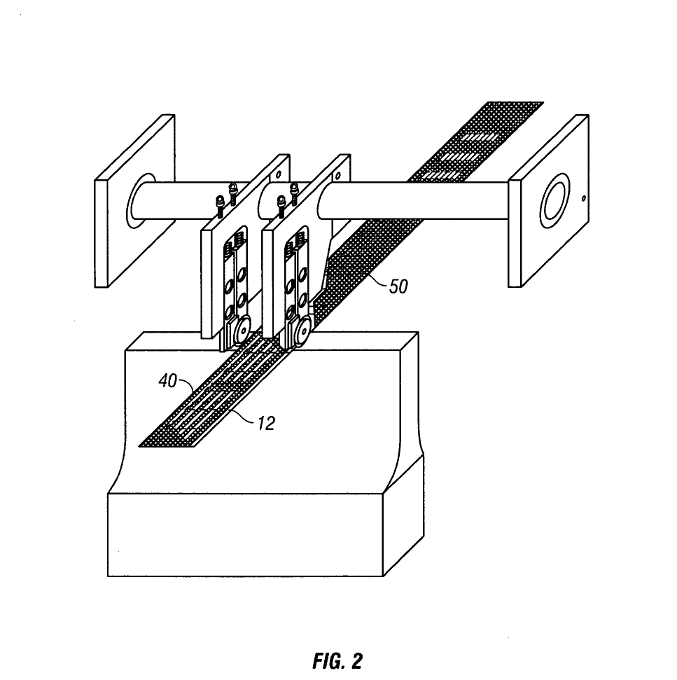

A schematic diagram of the system 10 of the present invention according to an embodiment is shown in FIGS. 1 and 2. As shown in FIG. 1, a first label 12 is dispensed from a roll 14 mounted on a first label dispenser 16. The dispensed first label 12 is threaded along rollers 18 and travels along a conveyor 20 and through an assembly unit 22. The first label 12 may be a top face label made from, for example, woven polyester, nylon, cotton, or a non-woven fabric.

Identification strips 24 are commonly obtained with an adhesive coupled to at least one side and placed on a backing paper. The identification strips 24 are dispensed on a sheet 26 wound from a roll 28 placed on a dispenser 30. The sheet 26 is threaded along rollers 32 and into the assembly unit 22.

The assembly unit 22 peels a backing paper 34 from each identification strip 24 to expose an adhesive on each identification strip and mounts the identification strip 24 to the first label 12. The backing paper 34 from the identification strips 24 is threaded to a backing paper takeup spool 36.

It will be understood by those skilled in the art, that the present invention may also be practiced using a roll of identification strips having no adhesive and no backing paper, the adhesive being applied to the identification strips as the identification strips are separated and applied to the first label. The identification strips may be separated from each other using readily tearable perforations or by using a cutter (not shown). When using a roll of identification strips with no backing paper, there is no backing paper takeup roll.

It will be understood by those skilled in the art, that the present invention may also be practiced using a roll of identification strips having an activateable adhesive and no backing paper. Where an activateable adhesive is used, the strips are dispensed from a roll prior to activation of the adhesive.

Optionally, the assembly unit 22 presses the identification strip 24 to the first label 12 to activate a pressure sensitive adhesive. Optionally, the assembly unit 22 heats the identification strip 24 and the first label 12 to activate a heat activated adhesive.

The first label 12 with the identification strips 24 mounted thereon continues along the conveyor 20. Optionally, a sensor 38 is placed above the conveyor 20 to monitor the position of the identification strips 24 on the first label 12. The sensor may be coupled to a warning light to advise an operator that the roll of identification strips is depleted. Additionally, the sensor may be coupled to a controller (not shown) that alters the speed of one or more of the first label dispenser, or the identification strip roll dispenser to alter the spacing of the identification strips 24 on the first label 12. The spacing of the identification strips 24 on the first label 12 affects how big the finished labels will be.

Further down the conveyor 20, a second label 40 is threaded from a second label roll 42 mounted on a second label dispenser 44 along rollers 46 and along the conveyor 20. The second label 40 may be a bottom face label made from, for example, woven polyester, nylon, cotton, or a non-woven fabric.

The second label 40 lays upon the identification strip 24 covered first label 12. The combination second label 40, first label 12, and identification strips 24 are fed through an ultrasonic sealing device 48 that seals the second label 40 to the first label 12 along the length of the first and second label to form a finished label 50. The finished label 50 is threaded along rollers 52 onto a finished label roll 54 mounted on a takeup spool 56. The finished label 50 is then passed through a second ultrasonic sealing device (not shown) which seals and cuts the finished label 50 across its width to create individual finished labels. The individual labels are ultrasonically sealed on all four sides, thereby hiding and protecting the identification strip contained within. Alternatively, the finished label 50 is slit across its width without sealing to create individual finished labels with two open sides for access to the identification strip.

Ultrasonic sealing devices usable with the present invention include, for example, ultrasonic slitters made by Dukane Corporation, 2900 Dukane Drive, St. Charles, Ill. 60174 and Ever Green Ultrasonic Co., Ltd., 2F, No. 13, Wu-Chuan 1st Rd., Hsin-Chuang City, Taipei Hsien, Taiwan. Ultrasonic slitters travel over a label, melt the material into a liquid and form the liquid into a seal. It will be recognized by those skilled in the art that other techniques of sealing the first label to the second label may be utilized. For example, the first label may also be sealed to the second label by sewing and stapling.

Each of the first label dispenser 16, the identification strip dispenser 30, and the second label dispenser 44, may be free spinning wheels, with the progress of the label system being driven by the finished label takeup spool 56. Alternatively, one or more of the first label dispenser 16, the identification strip dispenser 30, and the second label dispenser 44, may be motorized. Additionally, one skilled in the art will recognize that the positioning and number of rollers conveying each of the first label 12, the identification strips 24 and the second label 40 may be varied to allow for different positioning of the dispensers and takeup spool.

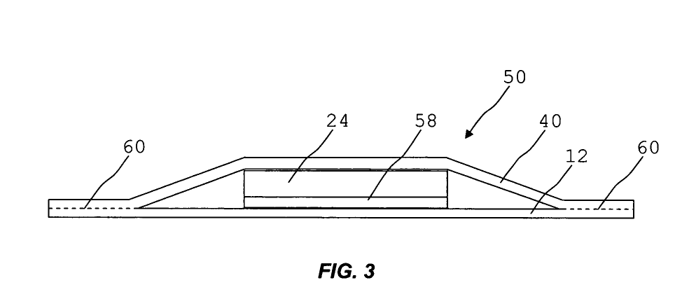

A finished label 50 according to an embodiment of the present invention is shown in FIG. 3. As shown in FIG. 3, the first label 12 defines a planar support for the identification strip 24. The first label 12 may be provided with indicia of the manufacturer, owner, composition or care instructions for a garment. The second label is a backing layer. Preferably the first label is a woven material and the second label is a lightweight flexible textile material, such as a non-woven fabric. The flexibility of the second label and the identification strip is preferably such that the identification strip and the second label do not appreciably stiffen the first label and so do not detract from the functionality of the finished label 50. The first label and the second label can be switched, with the first label being the backing layer.

The identification strip 24 is coupled to the first label 12 by an adhesive layer 58. The second label 40 and the first label 12 have marginal regions 60 that extend beyond the periphery of the identification strip. The finished label may be cut, but left unsealed, along two sides, thereby leaving access to the identification strip.

Alternatively, the marginal regions are bonded to one another, using an ultrasonic sealer so as to envelop the identification strip continuously around its periphery. This ensures that in use, the identification strip 24 does not move relative to the first and second labels, and ensures that the identification strip is retained internally of the finished label. Accordingly, the finished label may withstand washing and dry cleaning without losing its integrity. The finished label, can be attached to an item of clothing, for example, and remain with the garment for the life of the garment without detriment to the garment. The identification strip is unlikely to stain the garment or dislodge from the rest of the finished label.

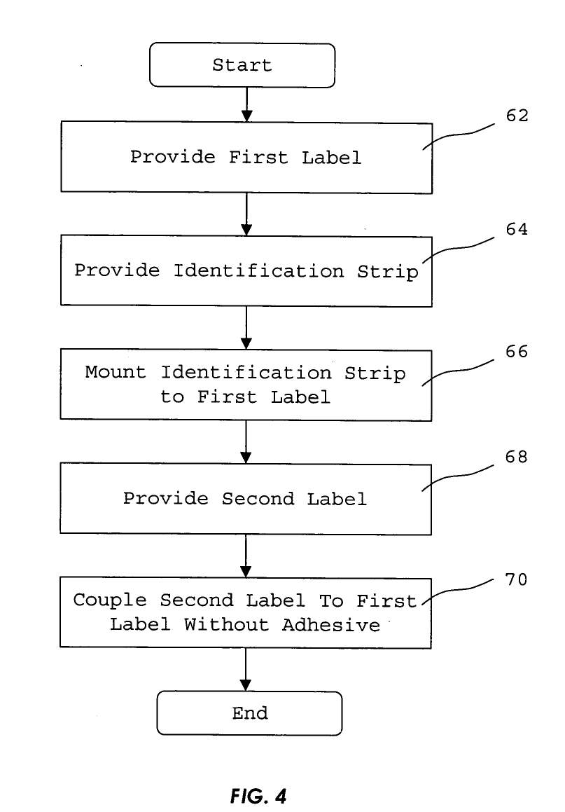

A method for manufacturing labels with electronic components according to the present invention is shown in FIG. 4. The method has the steps of providing a first label 62, providing an identification strip 64 and mounting an identification strip to the first label 66. A second label is provided 68. The second label is coupled to the first label without using an adhesive 70.

Coupling the second label to the first label can comprise passing the first label, identification strip and second label through a first ultrasonic slitter to seal and cut the labels on two sides to create a finished label. The finished label may be cut into individual open labels with two open sides, thereby providing access to the identification strip inside the label once the label is attached to a product. Alternatively, the first label, identification strip and second label can be passed through a second ultrasonic slitter to seal and cut the labels on the remaining two sides to form individual finished labels sealed on four sides having identification strips embedded therein.

Optionally, the method comprises the step of peeling a backing label from the identification strip to expose an adhesive before mounting the identification strip to the first label. Optionally, the method comprises the step of applying an adhesive to the identification strip before mounting the identification strip to the first label. Optionally, the mounting of the identification strip to the first label includes the steps of placing an identification strip with a heat activated adhesive onto the first label, and heating the first label and the identification strip to mount the identification strip to the first label.

By not using an adhesive on either the first label or the second label, the present system allows for improved ease of storage, transportation, and handling of the both the first label and the second label. The present system according to an embodiment using adhesive on the identification strip to bind the identification strip to the first label, and using an ultrasonic slitter to cut and seal the first label to the second label is faster, cleaner and simpler than prior art systems which also leads to cost savings.

Although the present invention has been described in considerable detail with reference to certain preferred versions thereof, other versions are possible. Therefore, the spirit and scope of the appended claims should not be limited to the description of the preferred versions described herein.

All features disclosed in the specification, including the claims, abstracts and drawings, and all the steps in any method or process disclosed, may be combined in any combination except combination where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

1. A method of making a label comprising:
a. providing a first label;
b. providing an identification strip;
c. mounting the identification strip to the first label;
d. providing a second label; and
e. coupling the second label to the first label without using an adhesive.

2. The method of claim 1 further comprising coating a portion of the identification strip with an adhesive before mounting the identification strip to the first label.

3. The method of claim 1 wherein the identification strip comprises an adhesive and a backing layer covering the adhesive; and the method further comprises removing the backing layer from the identification strip to expose the adhesive before mounting the identification strip to the first label.

4. The method of claim 1 wherein the second label is coupled to the first label using an ultrasonic sealing device.

5. A system for making a label comprising:
a first label dispenser dispensing a first label;
an identification strip dispenser, dispensing identification strips;
an assembly unit for mounting the identification strips onto the first label;
a second label dispenser dispensing a second label; and
a sealer for sealing the first label to the second label without using an adhesive.

6. The system for making a label of claim 5 wherein the sealer is an ultrasonic sealing device.

7. The system for making a label of claim 6 wherein the identification strips comprise a removable backing and wherein the system further comprises a identification strip backing takeup roll to takeup the removable backing once the removable backing is removed from the identification strips.

8. The system for making a label of claim 5 further comprising a finish label takeup roll.

9. A label comprising:
a first label;
a identification strip mounted on the first label; and
a second label sealed to the first label without an adhesive.

10. The label of claim 9 wherein the second label is ultrasonically sealed to the first label.

11. The label of claim 9 wherein the identification strip is mounted to the first label by an adhesive placed on the identification strip.

12. A system for making a label comprising:
a means for dispensing a first label;
a means for dispensing an identification strip;
a means for mounting the identification strip to the first label;
a means for dispensing a second label; and
a means for sealing the second label to the first label without an adhesive.
